(19) United States
(12) Patent Application Publication
(10) Pub. No.: US 2017/0189853 A1
(43) Pub. Date: Jul. 6, 2017

(54) DECONTAMINATING AND ELECTROCHROMIC POLYMER COATING FILM

(71) Applicant: Richard CAMARERO CERDAN, Valencia (ES)

(72) Inventor: Richard CAMARERO CERDAN, Valencia (ES)

(21) Appl. No.: 15/305,161

(22) PCT Filed: Apr. 24, 2015
(86) PCT No.: PCT/ES2015/000058

§ 371 Date: Dec. 21, 2016

(30) Foreign Application Priority Data
Apr. 20, 2014 (ES) P2014355

(51) Int. Cl. B01D 53/88; B01D 53/00; B05D 1/18; B05D 1/00; B05D 1/02; G02F 1/15; B01J 35/06; B01J 21/06; B01J 23/28; B01J 23/22; B01J 23/46; B01J 23/745; C03C 17/23; B01J 35/00

(52) U.S. Cl. CPC B01D 53/885; C03C 17/23; B01D 53/007; B05D 1/18; B05D 1/005; B05D 1/02; B01J 35/004; B01J 35/065; B01J 21/063; B01J 23/28; B01J 23/22; B01J 23/466; B01J 23/462; B01J 23/745; G02F 1/15; B01D 2255/802; B01D 2255/20707; C03C 2217/477; C03C 2217/48; C03C 2217/71; C03C 2218/111; C03C 2218/116; C03C 2218/112; C03C 2218/154; G02F 2001/1515

(57) ABSTRACT

Polymeric film of a semi rigid nature and with low opacity that contributes to environmental detoxification through the inclusion of titanium dioxide particles. It features photocatalytic properties within the range of visible light. The film permits the coating of surfaces such as windows by adhering to them and is thus easily removable. Versions in which the film includes at least one layer with electrochromic properties have been developed. It is intended for the chemicals and construction sectors.

### TECHNICAL FIELD

The present invention is comprised within the field of chemistry and construction, in particular the fields related to environmental protection and, specifically, those areas dealing with improvements in air detoxification and energy efficiency through the development of new functional polymers.

### BACKGROUND OF THE INVENTION

The state-of-the-art includes a wide range of inventions presenting solutions aimed at reducing air pollution or at controlling the passing of solar radiation through a glass. Thus, different types of concrete designed to capture air pollutants by including titanium dioxide in their composition are known. The result is a concrete with photocatalytic, anti-pollution activity such as the one developed under the 7^{th} Framework Agreement with the name “Visible LIGHT Active PhotoCATalytic Concretes for Air pollution Treatment” “Light2CAT”.

Other applications on glass aimed at obtaining ultra hydrophilic glass types through photocatalytic effects to remove pollutants and other deposits adhered to the surface are also known. These inventions preferably use titanium oxide, as does Japanese Patent No. JP-7-99425 by Toto Ltd. Thus, these inventions seek protection against ultraviolet rays while avoiding stains on the glass, but they do not aim at reducing air pollution through the photocatalytic action of titanium dioxide, the effect of which would be limited, since there is no doping procedure and it would only be active in the ultraviolet range. This latter aspect distinguishes those inventions from the solution proposed herein, the aim of which is to display an efficient anti-pollution activity. In addition, the proposed invention is a removable film coating, easily installable on any transparent surface.

There is a number of known methods to reduce solar transmission on glazing, such as the one described in Patent No. ES2010917 by Roy Gerald Gordon, based on integrating a permanent layer of titanium silicide into the glass. The invention proposed herein differs from the aforementioned patent in that stray light attenuation takes places through the intervention of raw materials with electrochromic behaviour.

The deposition of several layers of titanium dioxide, silicon nitride and silicon dioxide on a transparent glass substrate to generate a barrier against solar radiation, as described in Patent No. FR0552387 by Saint-Gobain Glass France, is also known. The latter invention clearly differs from the one claimed here in that the blocking of solar radiation takes places through electrochromic materials and, in addition, through magnetron spraying, so that the deposition cannot be removed from the glass.

No removable films featuring such amount of antipollution means or capable of attenuating solar radiation in an adjustable way without obstructing the effect of the antipollution means, such as the one proposed in this invention, are known.

### OBJECT OF THE INVENTION

Provide the industry with a flexible polymeric film capable of being adjusted to any even, transparent surface, such as glass or any transparent plastic—polymethyl methacrylate, among others—, with antipollution effect and capable of regulating the passing of light radiation.

### DESCRIPTION OF THE INVENTION

This invention offers solutions for glazing with different transparent surfaces such as glass or plastic. The coating film features properties contributing to environmental detoxification and is capable of regulating light radiation without obstructing the effect of the detoxifying external layer.

A significant advantage of this invention is the possibility of coating glass and other transparent elements already produced and installed such as, for instance, the glazing of a building, since it can be installed simply by adhering the film to those surfaces.

This invention proposes a film consisting of at least two layers to coat the aforementioned surfaces. On the one hand, the film includes a first layer exposed to the outside of the building to which the film is applied and featuring photocatalytic properties through the inclusion of TiO₂, in anatase phase, with a particle size ranging from 10 to 100 nm, which is activated by doping metallic elements such as Fe³⁺, Mo⁵⁺, Os³⁺, Ru³⁺, V⁴⁺ at levels ranging from 0.1% to 1%. This doping can also take place by using Nitrogen or colouring substances such as Rose Bengal, chlorophyll, porphyrins or phthalocyanins to reduce its band gap so that titanium dioxide can be activated within the visible light range and not only in the ultraviolet range. This doping takes places through conventional methods such as Sol-gel, ammonialysis or PLD. The deposition of the TiO₂ layer on the next layer takes places through conventional means, such as sintering, dip-coating, spin-coating, sputtering or spraying.

The film features a second layer acting as structural support and containing titanium dioxide in film form or disperse within the layer. The constituent material features transparency and flexibility and conventional plastics, such as PMMA, PET, PEDOT or PANI may be used. The thickness of this second layer ranges between 100 and 800 microns. The other side can be attached to the element to be coated through the electrostatic attraction forces existing between the structural support and the element to be coated or through the use of conventional adhesive substances. This allows for easy installation on the element to be coated such as, for instance, a glazing, without the need of installing glass treated during production. It suffices to adhere the film, which can thus be easily removed, if needed.

Other versions in which the film includes additional layers with electrochromic properties have been designed. In such versions, the film, in addition to increasing comfort and privacy where it is installed, can prevent solar radiation from entering the room without obstructing the functioning of the photocatalytic layer described above. This is made possible by adding at least five layers after the aforementioned structural support, which, together, constitute a new-generation, affordable electrochromic film consisting of: a layer which acts as activation electrode and features optic transparency through the inclusion of oxides such as ITO, SnO3-F or polymers such as PEDT/PSS; a layer formed by an electrochromic polymer opting for those based on polythiofenes such as PEDOT (poly (3,4-ethylenedioxythiophene)), PProDOT-Me2 (poly (3,4-propilenedioxythiophene) or those based on polyanillines such as PoAnis-TSA (poly o-Methoxyaniline) doped with p-Toluenesulfonic acid to carry out redox reactions; a layer formed by an ionic liquid responsible for charge transport, made of Lithium salts, such as LiClO4, or electrolyte polymers such as PVDF, PEO or PMMA, containing Lithium ions; a layer acting as second electrode, similar to the first electrode; and, finally, a supporting layer whose constituent material features transparency and flexibility; conventional plastics, such as PMMA, PET, PEDOT or PANI may be used. The thickness of this layer ranges between 100 and 800 microns and it can be attached to the element to be coated through electrostatic attraction forces between the structural support and the element to be coated or through the use of conventional adhesive substances.

An additional electrochromic layer similar to the one described above, located between the ionic conducting liquid and the electrode, can be added. This later is formed by polymers complementing the aforementioned polymers, i.e. if one polymer is transparent in oxidized state, the other one shall be transparent in reduced state; conventional complementary polymers, such as Poly (ET2), PBEDOT-N-MeCz (poly (3,6-bis[2-(3,4-ethylenedioxy)thienyl]- -N-methylcarbazole) or Poly (NNDMBP) may be used.

The film features a conventional power source and control system for the operation of the electrochromic set.

### BRIEF DESCRIPTION OF THE DRAWINGS

In order to better understand the concepts described in this application, drawings are attached, as examples only, representing the present invention.

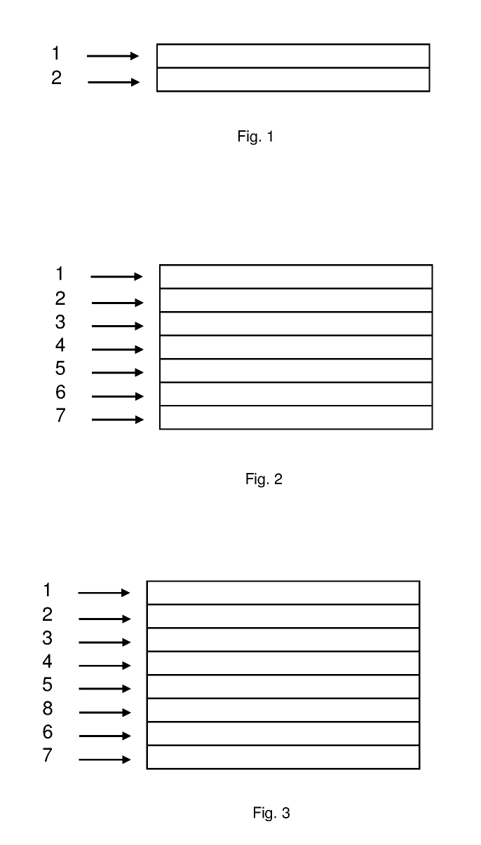

FIG. 1 shows:
(1) Titanium dioxide coating
(2) Protecting support

FIG. 2 shows:
(1) Titanium dioxide coating
(2) Protecting support
(3) Electrode
(4) Electrochromic polymer
(5) Ionic liquid
(6) Electrode
(7) Protecting support

FIG. 3 shows:
(1) Titanium dioxide coating
(2) Protecting support
(3) Electrode
(4) Electrochromic polymer
(5) Ionic liquid
(8) Electrochromic polymer
(6) Electrode
(7) Protecting support

### DESCRIPTION OF A PREFERRED EMBODIMENT

The preferred embodiment is described as follows by way of example, with the materials to be used for manufacture of the electrochromic and antipollution polymeric coating film being independent to the object of the invention, as are the methods of application and all accessory details that arise, provided that they do not affect the essentials of the invention.

The polymeric film described in this preferred embodiment is made up of seven layers:

The first layer, responsible for detoxifying the environment (1), features photocatalytic properties within the range of visible light, being composed of TiO₂ in anatase phase, with a particle size ranging from 10 to 100 nm, which is activated by doping metallic elements such as Fe3+, Mo5+, Os3+, Ru3+, V4+ at levels ranging from 0.1% to 1%.

This doping takes places through conventional methods such as Sol-gel, ammonialysis or PLD. The deposition of the TiO₂ layer on the next layer takes places through conventional means, such as sintering, dip-coating, spin-coating, sputtering or spraying.

A second layer (2) acting as structural support and containing titanium dioxide in film form or disperse within the layer. The constituent material features transparency and flexibility and conventional plastics, such as PMMA, PET, PEDOT or PANI may be used. The thickness of this second layer ranges between 100 and 800 microns.

The film includes means to prevent or limit the passing of solar radiation without preventing the normal functioning of the detoxifying film. This particularity allows the film to act as a blind without blocking the photocatalytic layer, since the electrochromic layers are located behind it, which is not the case for glasses treated during production. These means comprise:

A layer that acts as activation electrode (3) and features optic transparency through the inclusion of oxides such as ITO, SnO3-F or polymers such as PEDT/PSS.

A layer formed by an electrochromic polymer (4) opting for those based on polythiofenes such as PEDOT (poly(3,4-ethylenedioxythiophene)), PProDOT-Me2 (poly (3,4-propilenedioxythiophene) or those based on polyanillines such as PoAnis-TSA (poly o-Methoxyaniline) doped with p-Toluenesulfonic acid to carry out redox reactions.

A layer formed by an ionic liquid (5) responsible for charge transport, made of Lithium salts, such as LiClO4, or electrolyte polymers such as PVDF, PEO or PMMA, containing Lithium ions.

A layer acting as second electrode (6) of a nature similar to the first electrode.

A supporting layer (7) whose constituent material features transparency and flexibility; conventional plastics, such as PMMA, PET, PEDOT or PANI may be used. The thickness of this layer ranges between 100 and 800 microns and it can be attached to the element to be coated through the electrostatic attraction forces existing between the structural support and the element to be coated or through the use of conventional adhesive substances.

The film features a conventional power source and control system for the operation of the electrochromic set.

1. A coating film for environmental detoxification characterized by being a removable film of a semi rigid nature and with low opacity, consisting of at least two layers, where the first layer is exposed to the environment to be detoxified and presents photocatalytic properties within the range of visible light being composed of TiO₂ in anatase phase, with a particle size ranging from 10 to 100 nm, which is activated by doping metallic elements such as Fe³⁺, Mo⁵⁺, Os³⁺, Ru³⁺, V⁴⁺ at levels ranging from 0.1% to 1%; doping takes places through conventional methods such as Sol-gel, ammonialysis or PLD; the deposition of the TiO₂ on the next layer takes places through conventional means, such as sintering, dip-coating, spin-coating, sputtering or spraying; a second layer acting as structural support and containing titanium dioxide in film form or disperse within the layer; the constituent material features transparency and flexibility and conventional plastics, such as PMMA, PET, PEDOT or PANI may be used; the thickness of this second layer ranges between 100 and 800 microns; its other side can be attached to the element to be coated through the electrostatic attraction forces existing between the structural support and the element to be coated or through the use of conventional adhesive substances.

2. The coating film according to claim 1 characterized by the fact that the doping of titanium dioxide takes place through the use of colouring substances such as Rose Bengal, chlorophyll, porphyrins or phthalocyanins.

3. The coating film according to claim 1 characterized by the fact that the doping of titanium dioxide takes place through the use of Nitrogen to reduce its band gap.

4. The coating film according to claims 1 to 3 characterized by featuring means to limit or prevent the passing of light radiation into the building to be coated without obstructing the normal functioning of the detoxifying film due to the inclusion of at least 5 layers behind the structural support of titanium dioxide, which constitute a conventional electrochromic film; comprising a layer that acts as activation electrode and features optic transparency through the inclusion of oxides such as ITO, SnO3-F or polymers such as PEDT/PSS; a layer formed by an electrochromic polymer (4) opting for those based on polythiofenes such as PEDOT (poly(3,4-ethylenedioxythiophene)), PProDOT-Me2 (poly (3,4-propilenedioxythiophene) or those based on polyanillines such as PoAnis-TSA (poly o-Methoxyaniline) doped with p-Toluenesulfonic acid to carry out redox reactions; a layer formed by an ionic liquid responsible for charge transport, made of Lithium salts, such as LiClO4, or electrolyte polymers such as PVDF, PEO or PMMA, containing Lithium ions; a layer acting as second electrode, of a nature similar to the first electrode; a supporting layer whose constituent material features transparency and flexibility; conventional plastics, such as PMMA, PET, PEDOT or PANI may be used; the thickness of this layer ranges between 100 and 800 microns and it can be attached to the element to be coated through electrostatic attraction forces between the structural support and the element to be coated or through the use of conventional adhesive substances.

5. The coating film according to claim 1 characterized by featuring an additional layer made of an electrochromic polymer; this layer is similar to the layer of the first polymer making up the film and is made of polymers that are complementary to the aforementioned polymers, i.e. if one polymer is transparent in oxidized state, the other one shall be transparent in reduced state; conventionally used complementary polymers, such as Poly (ET2), PBEDOT-N-MeCz (poly (3,6-bis[2-(3,4-ethylenedioxy)thienyl]- -N-methylcarbazole) or Poly (NNDMBP) may be used.
